(19) United States
(12) Patent Application Publication
(10) Pub. No.: US 2025/0067467 A1
(43) Pub. Date: Feb. 27, 2025

(54) DEVICE FOR HEATING A HEAT-TRANSFER LIQUID CIRCULATING WITHIN A CIRCUIT EQUIPPING AN ELECTRIC OR HYBRID VEHICLE

(71) Applicant: VALEO SYSTEMES THERMIQUES, Le Mesnil-Saint-Denis (FR)

(72) Inventor: Laurent Decool, Le Mesnil-Saint-Denis (FR)

(73) Assignee: VALEO SYSTEMES THERMIQUES, Le Mesnil-Saint-Denis (FR)

(21) Appl. No.: 18/725,551

(22) PCT Filed: Dec. 6, 2022
(86) PCT No.: PCT/EP2022/084531

§ 371 Date: Jun. 28, 2024

(30) Foreign Application Priority Data
Dec. 31, 2021 (FR) FR2114711

(51) Int. Cl. F24H 1/10; B60H 1/22

(52) U.S. Cl. CPC F24H 1/102; B60H 1/2221

(57) ABSTRACT

A heating device includes a heat-transfer liquid that circulates within a heat-transfer liquid circuit. The heating device includes a casing that houses a circulation channel. The channel contains a heating resistor extending between a first and second block secured to the casing. The first block extends along a first axis and the second block extends along a second axis. The heating resistor extends at least partially within a plane that intersects at least one of the first axis or second axis.

The field of the present invention is that of heating devices for heating a heat-transfer liquid intended to circulate within a heat-transfer liquid circuit with which an electric or hybrid vehicle is equipped. One subject of the invention is such a heating device. Another subject of the invention is a heat-transfer liquid circuit comprising such a heating device. Yet another subject of the invention is an electric or hybrid vehicle provided with such a heat-transfer liquid circuit.

Electric or hybrid vehicles are equipped with an electric motor in order to allow them to move. Electric motors are characterized by producing little heat during operation. However, it is currently necessary to provide a source of heat on board the vehicle in order to heat an element of the vehicle, such as electric battery cells, and/or in order to heat an airflow intended to be admitted within an interior of the vehicle in order to heat air contained within the interior. To this end, the vehicle is for example equipped with a heating device for heating a heat-transfer liquid circulating within a heat-transfer liquid circuit. The heat-transfer liquid circuit also comprises a heat exchanger, which is arranged so as to heat the element of the vehicle, and/or a radiator, which is configured to heat the airflow before it is supplied into the interior.

The heating device comprises a casing that houses a circulation channel for circulating the heat-transfer fluid, said channel containing a heating resistor. When an electrical current flows through the latter, there is an increase in the temperature of the heating resistor as a result of Joule heating, which causes the heat-transfer liquid to heat up upon contact. The circulation of the heat-transfer liquid within the heat-transfer liquid circuit thus makes it possible to heat the heat exchanger and the radiator, in order to heat the element of the vehicle and the airflow.

Document FR3104204 describes a heating device of the abovementioned type, the heating resistor of which is arranged in a spiral within the circulation channel for circulating the heat-transfer fluid.

Such an arrangement of the heating resistor requires the circulation channel, and in turn the heating device, to have a significant bulk. There is therefore a constant search for ways to minimize an overall volume of the devices installed on board the vehicle. It is therefore desirable to provide a heating device that is as compact as possible for an equivalent heating power.

Such an arrangement of the heating resistor also makes the heat-transfer liquid flowing within the circulation channel likely to be at a distance from the heating resistor, which is for example the case for a heat-transfer liquid fraction circulating along an axis of extension of the spiral about which the heating resistor extends. Such distance adversely affects the heating of this heat-transfer liquid fraction, which reduces an overall efficiency of the heating device.

The present invention falls within this context and proposes a heating device for heating a heat-transfer liquid intended to circulate within a heat-transfer liquid circuit with which an electric or hybrid vehicle is equipped. The heating device comprising a casing that houses at least one circulation channel for circulating the heat-transfer fluid, said channel containing at least one heating resistor. The heating resistor extends between a first block and a second block that are secured to the casing. The first block extends along a first axis and the second block extends along a second axis.

According to the present invention, the heating resistor extends at least partially within a plane that intersects at least either one of the first axis and the second axis. Preferably, the resistor extends mainly within this plane. This feature reduces an overall bulk of the heating device. More particularly, such a bulk is in particular reduced in a direction that is orthogonal to the plane in which the heating resistor is mainly inscribed.

The fact that the first axis and/or the second axis along which the first block and the second block extend, respectively, intersect(s) the plane in which the heating resistor is inscribed offers a multiplicity of possible connections for these blocks with an electrical circuit that supplies the heating resistor with electrical energy.

The heating device advantageously comprises at least any one of the following technical features, considered individually or in combination:
the plane intersects the first axis and the second axis,
the plane is orthogonal to the first axis and the second axis,
the heating resistor comprises a planar portion that is contained within the plane and has a portion length, the portion length corresponding to at least 90% of a total length of the heating resistor measured between the first block and the second block. It will be understood that at least 90% of the heating resistor is inscribed within the plane in which the latter is comprised,
the planar portion comprises a first end, which is connected to the first block via at least one first elbow, and a second end, which is connected to the second block via at least one second elbow. In order to make it easier to connect the planar portion of the heating resistor to the connection blocks, the heating resistor has two elbows having a total length that is shorter than 10% of the total length of the heating resistor,
the planar portion comprises at least one part arranged in the shape of a U, and a region arranged in the shape of a J, between which a portion arranged in the shape of a circular arc is interposed. In order to optimize the portion length comprised within the plane and to make this length as long as possible, the heating resistor describes zigzags comprising at least one part arranged in the shape of a U, and a region arranged in the shape of a J, between which a portion arranged in the shape of a circular arc is formed,
the circulation channel comprises a first chamber that at least partially houses the first block, a second chamber that at least partially houses the second block, and a pipe interposed between the first chamber and the second chamber. It will be understood that the circulation channel predominantly comprises a pipe that is interposed between two chambers,
the first chamber houses the first elbow, the second chamber houses the second elbow, and the pipe houses the planar portion,
a first passage section for passage of the heat-transfer liquid within the first chamber is more than twice the size of a passage surface for passage of the heat-transfer liquid within the pipe,
a second passage section for passage of the heat-transfer liquid within the second chamber is more than twice the size of the passage surface for passage of the heat-transfer liquid within the pipe,
over substantially the entire length of the resistor, a minimum distance, measured between a partition delimiting the circulation channel and the heating resistor, is between 2 mm and 4 mm, preferably the distance is 3 mm, to within +/−10%,
over substantially the entire length of the resistor, a maximum distance, measured between a partition delimiting the circulation channel and the heating resistor (4, 5) is between 2 mm and 4 mm,
the casing is parallelepipedal and comprises a first wall provided with an inlet opening, which lets heat-transfer liquid in and is in fluidic communication with the circulation channel, and with a discharge opening, which discharges heat-transfer liquid and is in fluidic communication with the circulation channel,
the casing comprises a second wall, which is orthogonal to the first wall and is provided with a receiving orifice for receiving the first block and with a housing orifice for housing the second block,
the second wall extends within a plane that is parallel to the plane in which the heating resistor is inscribed,
each of the first block and the second block is provided with at least one peripheral groove for receiving a seal that forms a seal with the second wall,
the second wall borders a first compartment that houses the circulation channel for circulating the heat-transfer liquid, and a second compartment that houses control means for controlling the heating resistor,
the circulation channel houses at least two heating resistors, including a first heating resistor extending between a first connection block and a second connection block, the first connection block extending along a first axis of extension and the second connection block extending along a second axis of extension, the first heating resistor extending mainly within a first plane that intersects the first axis of extension and the second axis of extension, and including a second heating resistor extending between a first joining block and a second joining block, the first joining block extending along a first axis of elongation and the second joining block extending along a second axis of elongation, the second heating resistor extending mainly within a second plane that is parallel to the first plane,
the first axis of extension, the second axis of extension, the first axis of elongation and the second axis of elongation are parallel to one another,
the first heating resistor comprises a first planar portion, which is contained within the first plane and is superposed on a second planar portion comprised by the second resistor along a direction that is orthogonal to the first plane and the second plane,
the connection blocks and the joining blocks are distributed along the same axis of alignment,
the axis of alignment is parallel to a plane in which the first wall extends.

The present invention also relates to a heat-transfer liquid circuit with which an electric or hybrid vehicle is equipped, comprising such a heating device, wherein the heat-transfer liquid circuit comprises at least one heat exchanger housed within a heating, ventilation and/or air-conditioning system in order to heat an airflow circulating within said system.

The present invention also relates to an electric or hybrid vehicle equipped with such a heat-transfer liquid circuit.

Other features and advantages of the invention will become more clearly apparent both from the following description and from several exemplary embodiments, which are given by way of non-limiting indication with reference to the attached schematic drawings, in which:

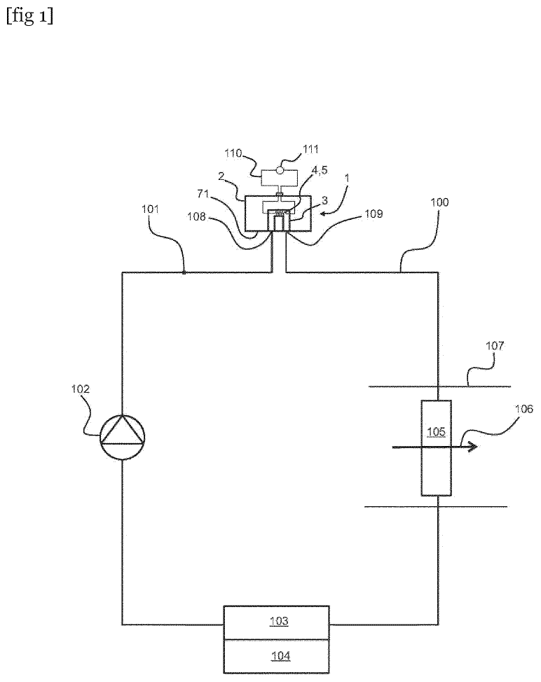

FIG. 1 is a schematic illustration of a heat-transfer liquid circuit according to the present invention,

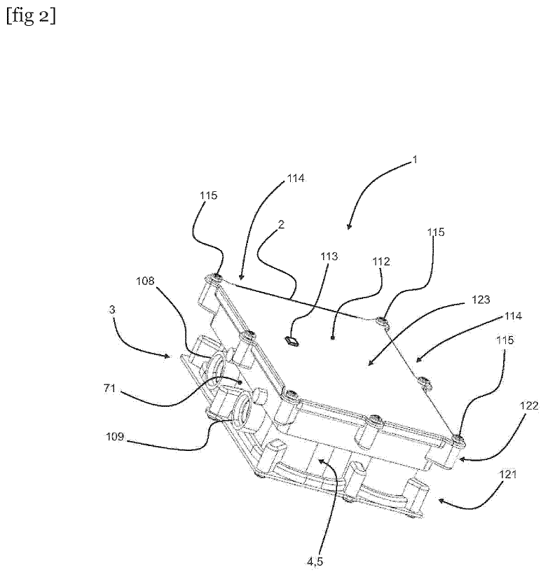

FIG. 2 is a schematic, perspective illustration, from the side, of a heating device of the present invention that forms part of the heat-transfer liquid circuit illustrated in FIG. 1,

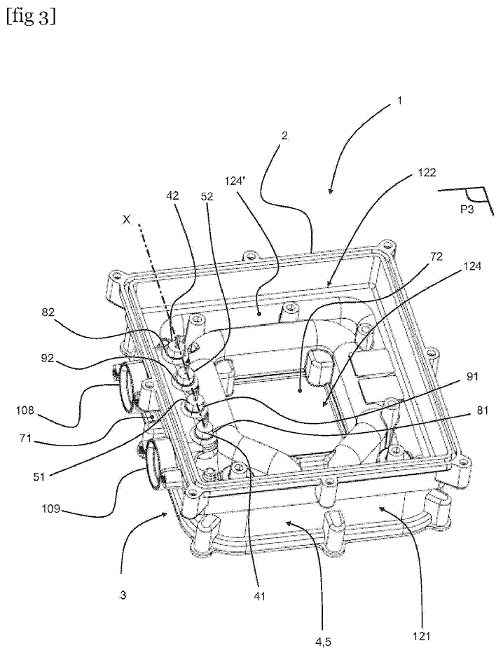

FIG. 3 is a schematic, perspective illustration, from above, of a first alternative embodiment of the heating device illustrated in FIG. 2 with a cover removed,

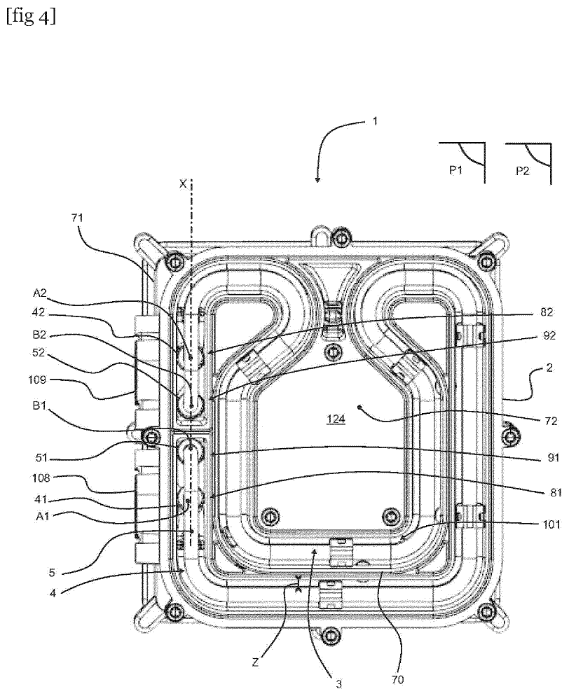

FIG. 4 is a schematic illustration, from above, of the heating device illustrated in FIG. 3,

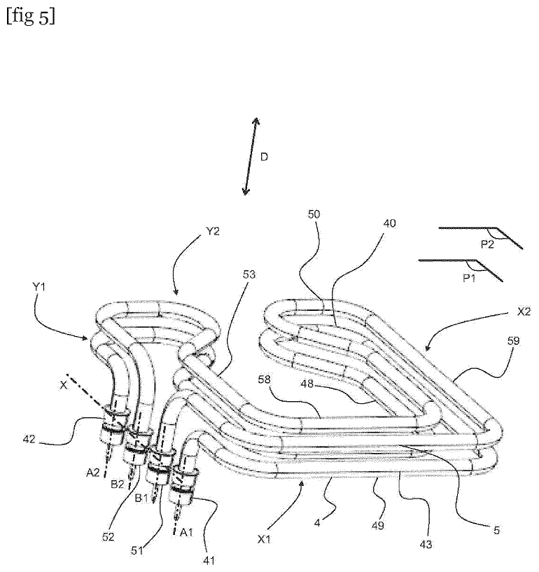

FIG. 5 is a schematic, perspective illustration, from below, of heating resistors that form part of the heating device illustrated in FIGS. 2 to 4,

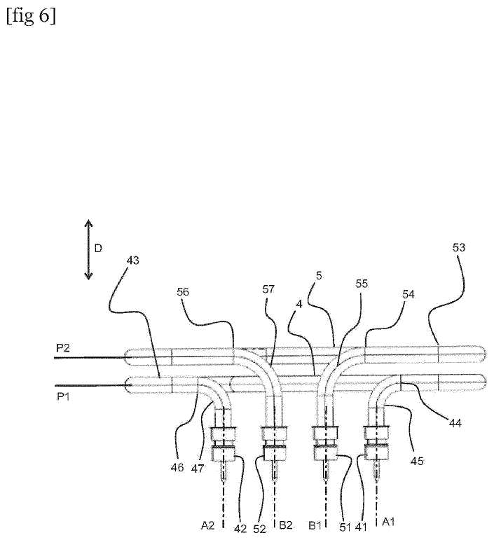

FIG. 6 is a schematic illustration, from the side, of the heating resistors illustrated in FIG. 5,

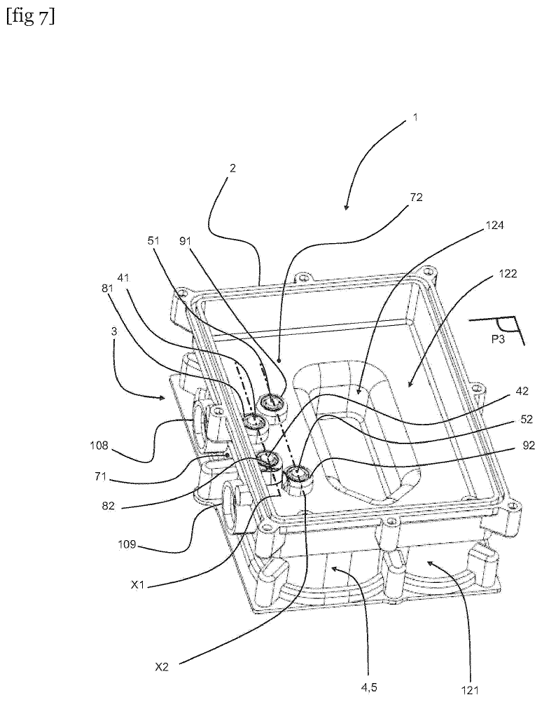

FIG. 7 is a schematic, perspective illustration, from above, of a second alternative embodiment of the heating device illustrated in FIG. 2 with a cover removed,

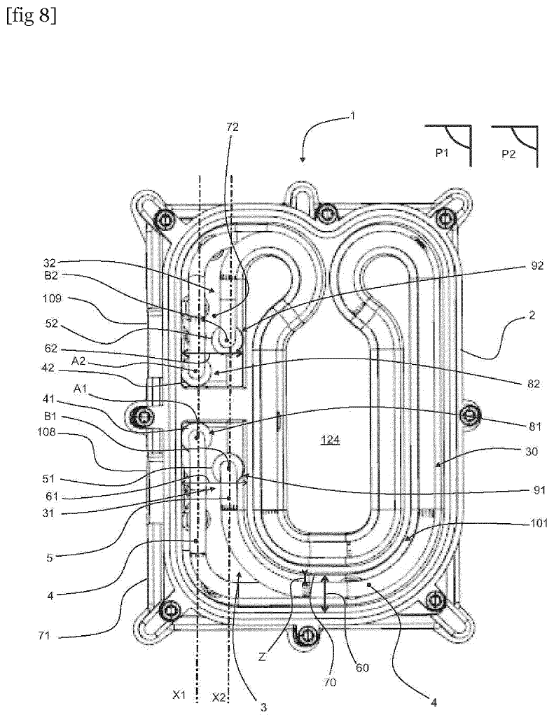

FIG. 8 is a schematic illustration, from above, of the heating device illustrated in FIG. 7,

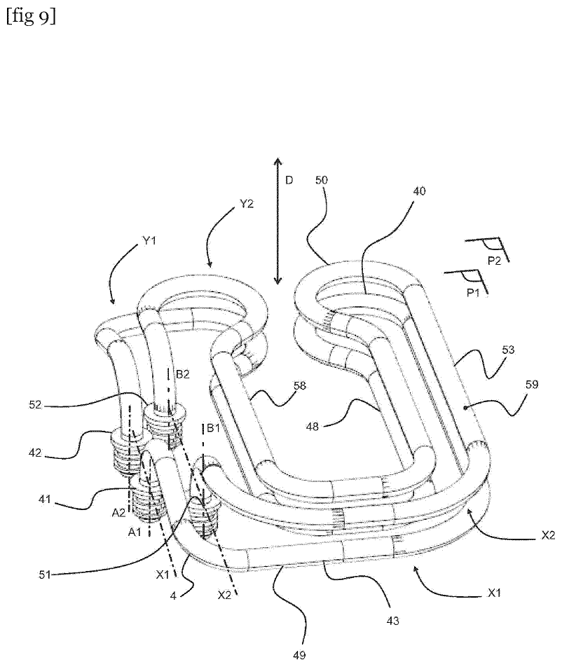

FIG. 9 is a schematic, perspective illustration, from below, of heating resistors that form part of the heating device illustrated in FIG. 2 and FIGS. 7 and 8,

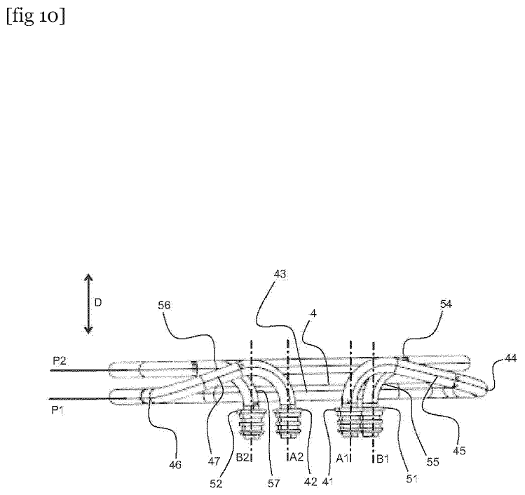

FIG. 10 is a schematic illustration, from the side, of the heating resistors illustrated in FIG. 9,

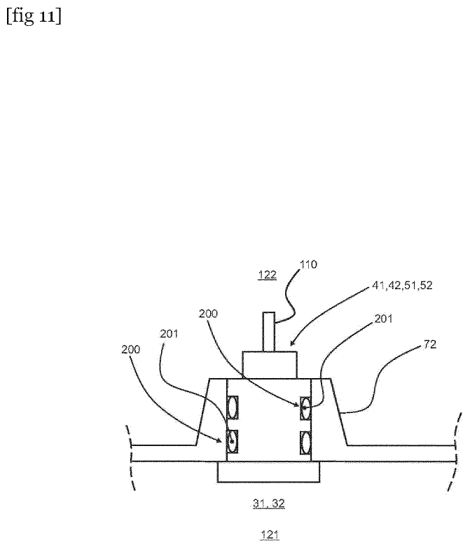

FIG. 11 is a schematic illustration of a cross section through a block that forms part of the heating resistors illustrated in FIGS. 5, 6, 9 and 10.

In FIG. 1, a vehicle, in particular a motor vehicle, which is an electric or hybrid vehicle, is equipped with a heat-transfer liquid circuit 100. Such a vehicle is provided with at least one electric motor in order to enable it to move. More particularly, an electric vehicle is equipped solely with an electric motor in order to allow it to move, whereas a hybrid vehicle is equipped with an internal combustion engine and an electric motor in order to enable the vehicle to move.

The heat-transfer liquid circuit 100 is a closed loop within which a heat-transfer liquid 101, such as glycol water or the like, circulates. The heat-transfer liquid circuit 100 comprises a pump 102 for making the heat-transfer liquid 101 circulate within the heat-transfer liquid circuit 100. The heat-transfer liquid circuit 100 also comprises a heat exchanger 103, which is arranged so as to effect heat exchange between the heat-transfer liquid 101 present within the heat exchanger 103 and an element 104 of the vehicle. The element 104 of the vehicle is for example a battery element that it is desirable to heat during a period throughout which a temperature external to the vehicle is low, in particular negative when expressed in degrees Celsius. The heat-transfer liquid circuit 100 also comprises a radiator 105 that is configured to exchange heat energy with an airflow 106 intended to be supplied into the interior of the vehicle. To this end, the airflow 106 circulates within a heating, ventilation and/or air-conditioning system 107 that houses the radiator 105, which is provided in particular in order to heat the airflow 106 before it is supplied into the interior of the vehicle.

The heat-transfer liquid circuit 100 also comprises a heating device 1 for heating the heat-transfer liquid, which has an inlet opening 108 for letting the heat-transfer liquid 101 into the heating device 1, and a discharge opening 109 for discharging the heat-transfer liquid 101 from the heating device 1. The inlet opening 108 is the orifice via which the heat-transfer liquid 101 penetrates within the heating device 1 while the discharge opening 109 is the orifice via which the heat-transfer liquid 101 is discharged from the heating device 1. The inlet opening 108 and the discharge opening 109 are formed through a first wall 71 delimiting a casing 2 that houses at least one circulation channel 3 for circulating the heat-transfer liquid 101. In other words, the heat-transfer liquid 101 circulates within the casing 2 within the circulation channel 3 from the inlet opening 108 to the discharge opening 109.

The circulation channel 3 houses at least one heating resistor 4, 5 that forms part of an electrical circuit 110. The electrical circuit 110 also has an electrical energy source 111, which can supply electrical energy that the heating resistor 4, 5 transforms into heat as a result of Joule heating. From this conversion, the heating resistor 4, 5 can heat the heat-transfer liquid 101 circulating within the circulation channel 3.

In FIG. 2, the casing 2 is generally parallelepipedal and delimits a first compartment 121 that houses the circulation channel 3 for circulating the heat-transfer liquid 101, and a second compartment 122 that houses control means 123 for controlling the heating resistor 4, 5. The casing 2 also comprises a cover 112 that is provided with an electrical connection member 113 that can connect the heating resistor 4, 5 to the electrical energy source 111. The cover 112 is attached to edges 114 that delimit the second compartment 122 using screw-fastening means 115 or the like.

In FIGS. 3 to 10, the circulation channel 3 houses two separate heating resistors 4, 5, including a first heating resistor 4 extending between a first connection block 41 and a second connection block 42, and a second heating resistor 5 extending between a first joining block 51 and a second joining block 52.

A first alternative embodiment of the heating device 1 is illustrated in FIGS. 3 to 6, and a second alternative embodiment of the heating device 1 is illustrated in FIGS. 7 to 10. These two alternatives differ in particular in terms of a separate configuration of the heating resistors 4, 5 and in terms of a different arrangement of a second wall 72 that is housed by the casing 2 and delimits the second compartment 122. It should be noted that, according to the two alternatives, the second wall 72 extends generally within a wall plane P3 that is orthogonal to the plane in which the first wall 71 extends.

The first connection block 41, the second connection block 42, the first joining block 51 and the second joining block 52 are secured to the second wall 72. More particularly, the second wall 72 is provided with a first receiving orifice 81 for receiving the first connection block 41 and with a second receiving orifice 82 for receiving the second connection block 42. The second wall 72 is also provided with a first housing orifice 91 for housing the first joining block 51 and with a second housing orifice 92 for housing the second joining block 52.

The second wall 72 also has a bowl 124 that extends within the first compartment 121 in order to at least partially delimit the circulation channel 3. In FIG. 3, the second wall 72 also has bosses 124′ that at least partially delimit the circulation channel 3.

It should be noted at this stage of the description that the second wall 72 is for example obtained by stamping a metal strip, which is in particular made from aluminum or the like, in order to form the orifices 81, 82, 91, 92 and the bowl 124, and optionally the bosses 124′.

In FIGS. 3 and 4, the orifices 81, 82, 91, 92 are distributed along the same axis of alignment X, the receiving orifices 81, 82 being interposed between the housing orifices 91, 92. Similarly, the blocks 41, 42, 51, 52 are distributed along the same axis of alignment X, the connection blocks 41, 42 being interposed between the joining blocks 51, 52.

In FIG. 4, the circulation channel 3 extends in a uniform manner between the inlet opening 108 and the discharge opening 109. Thus, a minimum distance Z, measured between a partition 70 delimiting the circulation channel 3 and the heating resistor 4, 5, is between 2 mm and 4 mm, preferably equal to 3 mm. The same applies to the maximum distance. These arrangements enable the heating resistors 4, 5 to rapidly and uniformly heat the heat-transfer fluid 101 circulating within the circulation channel 3. In FIGS. 5, 6, 9 and 10, the first connection block 41 extends along a first axis of extension A1 and the second connection block 42 extends along a second axis of extension A2. The first joining block 51 extends along a first axis of elongation B1 and the second joining block 52 extends along a second axis of elongation B2. The first heating resistor 4 extends mainly within a first plane P1 that intersects the first axis of extension A1 and the second axis of extension A2. The second heating resistor 5 extends mainly within a second plane P2 that is parallel to the first plane P1. In other words, the second plane P2 also intersects the first axis of elongation B1 and the second axis of elongation B2.

Preferably, the first plane P1 and the second plane P2 are orthogonal to the first axis of extension A1, the second axis of extension A2, the first axis of elongation B1 and the second axis of elongation B2. It should also be noted that the first plane P1 and the second plane P2 are parallel to the wall plane P3 within which the second wall 72 extends.

It should be noted that the first heating resistor 4 comprises a first planar portion 43 contained within the first plane P1 and that the second heating resistor 5 comprises a second planar portion 53 contained within the second plane P2. The first planar portion 43 has a first portion length X1 and the second planar portion 53 has a second portion length X2. It should be noted that the first portion length X1 corresponds to at least 90% of a first total length Y1 of the first heating resistor 4 measured between the first connection block 41 and the second connection block 42. Similarly, it should be noted that the second portion length X2 corresponds to at least 90% of a second total length Y2 of the second heating resistor 5 measured between the first joining block 51 and the second joining block 52. It is in this way that the first heating resistor 4 extends mainly within the first plane P1 and the second heating resistor 5 extends mainly within the second plane P2.

The first planar portion 43 comprises a first planar portion first end 44 that is connected to the first connection block 41 via at least one first planar portion first elbow 45. The first planar portion 43 also comprises a first planar portion second end 46 that is connected to the second connection block 42 via at least one first planar portion second elbow 47. Similarly, the second planar portion 53 comprises a second planar portion first end 54 that is connected to the first joining block 51 via at least one second planar portion first elbow 55. The second planar portion 53 also comprises a second planar portion second end 56 that is connected to the second joining block 52 via at least one second planar portion second elbow 57.

Additionally, the first planar portion 43 comprises at least one first part 48 arranged in the shape of a U, and a first region 49 arranged in the shape of a J, between which a first portion 40 arranged in the shape of a circular arc is interposed. Similarly, the second planar portion 53 comprises at least one second part 58 arranged in the shape of a U, and a second region 59 arranged in the shape of a J, between which a second portion 50 arranged in the shape of a circular arc is interposed.

It should also be noted that the first chamber 31 houses the first planar portion first elbow 45 and the second planar portion first elbow 55. Similarly, the second chamber 32 houses the first planar portion second elbow 47 and the second planar portion second elbow 57. Finally, the pipe 30 houses the first planar portion 43 and the second planar portion 53.

It should be noted that the first axis of extension A1, the second axis of extension A2, the first axis of elongation B1 and the second axis of elongation B2 are parallel to one another and orthogonal to the planes P1 and P2. It should also be noted that the first planar portion 43 of the first heating resistor 4 is superposed on the second planar portion 53 along a direction D that is orthogonal to the first plane P1 in which the first planar portion 43 extends and to the second plane P2 in which the second planar portion 53 extends.

In FIGS. 7 and 8, the receiving orifices 81, 82 are formed along a first axis of alignment X1 and the housing orifices 91, 92 are formed along a second axis of alignment X2, which is separate from the first axis of alignment X1 and preferably parallel to the first axis of alignment X1. Thus, the orifices 81, 82, 91, 92 are distributed at the corners of a quadrilateral, in particular a parallelogram. Similarly, the connection blocks 41, 42 are distributed along the same first axis of alignment X1 and the joining blocks 51, 52 are distributed along the same second axis of alignment X2.

In FIG. 8, the circulation channel 3 comprises a first chamber 31 that is in fluidic communication with the inlet opening 108 for letting heat-transfer liquid 101 in and a second chamber 32 that is in fluidic communication with the discharge opening 109 for discharging heat-transfer liquid 101. The first chamber 31 at least partially houses the first blocks 41, 51 and the second chamber 32 at least partially houses the second blocks 42, 52.

The circulation channel 3 also comprises a pipe 30 interposed between the first chamber 31 and the second chamber 32. The pipe 30 creates a restriction on the circulation of the heat-transfer liquid 101 between the first chamber 31 and the second chamber 32 in order to optimize heat exchange between the heating resistors 4, 5 and the heat-transfer liquid 101 circulating within the pipe 30. Thus, a first passage section 61 for passage of the heat-transfer liquid 101 within the first chamber 31 is more than twice the size of a passage surface 60 for passage of the heat-transfer liquid 101 within the pipe 30. Similarly, a second passage section 62 for passage of the heat-transfer liquid 101 within the second chamber 32 is more than twice the size of the passage surface 60 for passage of the heat-transfer liquid 101 within the pipe 30. To this end, a minimum distance Z, measured between a partition 70 delimiting the pipe 30 and the heating resistor 4, 5, is between 2 mm and 4 mm, preferably equal to 3 mm. These arrangements enable the heating resistors 4, 5 to rapidly and uniformly heat the heat-transfer fluid 101 circulating within the pipe 30.

The first chamber 31 houses the first planar portion first elbow 45 and the second planar portion first elbow 55. Similarly, the second chamber 32 houses the first planar portion second elbow 47 and the second planar portion second elbow 57.

Finally, the pipe 30 houses the first planar portion 43 and the second planar portion 53.

In FIG. 11, each block 41, 42, 51, 52 is provided with at least one peripheral groove 200, and preferably two peripheral grooves 200, for receiving a seal 201 that forms a seal with the second wall 72, in order to provide sealing between the first compartment 121 and the second compartment 122.

1. A heating device for heating a heat-transfer liquid wherein the heat-transfer liquid circulates within a heat-transfer liquid circuit with which an electric or hybrid vehicle is equipped,
the heating device comprising a casing that houses at least one circulation channel for circulating the heat-transfer liquid,
wherein the channel contains at least one heating resistor extending between a first block and a second block that are secured to the casing,
wherein the first block extends along a first axis and the second block extends along a second axis,
wherein the heating resistor extends at least partially within a plane that intersects at least either one of the first axis and the second axis.

2. The heating device as claimed in claim 1,
wherein the plane intersects the first axis and the second axis.

3. The heating device as claimed in claim 1,
wherein the plane is orthogonal to the first axis and the second axis.

4. The heating device as claimed in claim 1,
wherein the heating resistor comprises a planar portion that is contained within the plane and has a portion length,
wherein the portion length corresponds to at least 90% of a total length of the heating resistor measured between the first block and the second block.

5. The heating device as claimed in claim 1, wherein the planar portion comprises:
a first end, which is connected to the first block via at least one first elbow, and
a second end, which is connected to the second block via at least one second elbow.

6. The heating device as claimed in claim 4,
wherein the planar portion comprises at least one part arranged in the shape of a U, and a region arranged in the shape of a J, between which a portion arranged in the shape of a circular arc is interposed.

7. The heating device as claimed in claim 1,
wherein, over length of the resistor, a maximum distance, measured between a partition delimiting the circulation channel and the heating resistor, is between 2 mm and 4 mm.

8. The heating device as claimed in claim 1,
wherein the casing is parallelepipedal and comprises a first wall provided with an inlet opening, which lets heat-transfer liquid in and is in fluidic communication with the circulation channel, and
wherein the first wall is provided with a discharge opening, which discharges heat-transfer liquid and is in fluidic communication with the circulation channel.

9. The heating device as claimed in claim 8,
wherein the casing comprises a second wall, which is orthogonal to the first wall and is provided with a receiving orifice for receiving the first block and
wherein the second wall is provided with a housing orifice for housing the second block.

10. The heating device as claimed in claim 9,
wherein the second wall extends within a plane that is parallel to the plane in which the heating resistor is inscribed.

11. The heating device as claimed in claim 9,
wherein each of the first block and the second block is provided with at least one peripheral groove for receiving a seal that forms a seal with the second wall.

12. The heating device as claimed in claim 1,
wherein the second wall borders a compartment that is able to receive control means for controlling the heating device.

13. The heating device as claimed in claim 4,
wherein the circulation channel houses at least two heating resistors,
wherein a first heating resistor of the at least two heating resistors extends between a first connection block and a second connection block,
wherein the first connection block extends along a first axis of extension and the second connection block extends along a second axis of extension,
wherein the first heating resistor extends mainly within a first plane that intersects the first axis of extension and the second axis of extension, and
wherein a second heating resistor of the at least two heating resistors (5) extends between a first joining block and a second joining block,
wherein the first joining block extends along a first axis of elongation and the second joining block extends along a second axis of elongation,
wherein the second heating resistor extends mainly within a second plane that is parallel to the first plane.

14. The heating device as claimed in claim 15,
wherein the first axis of extension, the second axis of extension, the first axis of elongation and the second axis of elongation are parallel to one another.

15. The heating device as claimed in claim 13,
wherein the first heating resistor comprises a first planar portion, which is contained within the first plane and is superposed on a second planar portion comprised by the second resistor along a direction that is orthogonal to the first plane and the second plane.

16. The heating device as claimed in claim 13,
wherein the connection blocks and the joining blocks are distributed along the same axis of alignment.
